(19) United States
(12) Patent Application Publication
(10) Pub. No.: US 2021/0178622 A1
(43) Pub. Date: Jun. 17, 2021

(54) METHOD AND APPARATUS FOR GENERATING FIDUCIAL VIA DIE CUTTING

(71) Applicant: 3M INNOVATIVE PROPERTIES COMPANY, St. Paul, MN (US)

(72) Inventors: Thomas J. Metzler, St. Paul, MN (US); James Zhu, Woodbury, MN (US); Daniel J. Theis, Mahtomedi, MN (US); David D. Miller, North Saint Paul, MN (US); Donald G. Peterson, Shoreview, MN (US); Mikhail L. Pekurovsky, Bloomington, MN (US)

(21) Appl. No.: 16/758,604

(22) PCT Filed: Oct. 18, 2018
(86) PCT No.: PCT/IB2018/058114

§ 371 Date: Apr. 23, 2020

Related U.S. Application Data
(60) Provisional application No. 62/576,327, filed on Oct. 24, 2017.

(51) Int. Cl. B26D 3/08; B26F 1/38; B26D 5/00

(52) U.S. Cl. CPC B26D 3/085; B26D 5/007; B26F 1/384

(57) ABSTRACT

Methods and apparatuses for generating fiducials via die cutting are provided. Laterally arranged die cutting members and fiducial-making members are provided onto a roller to respectively cut a first pattern and a fiducial mark on the same side of a web in a rotatory die cutting process. The fiducial mark is used to register a second pattern provided by a downstream station to the first pattern.

### TECHNICAL FIELD

The present disclosure relates to methods and apparatuses for generating fiducials via die cutting, and methods of using the fiducials.

### BACKGROUND

Patterned cutting mechanisms such as rotary dies have been widely used. A web can be fed between die cutting rollers that cut into the web surface to make patterns thereon.

### SUMMARY

There is a desire to precisely register a die-cutting pattern on a web with a second pattern provided by a downstream station. Briefly, in one aspect, the present disclosure describes an apparatus including a first roller and a second roller, each rotatably mounted adjacent to each other with the respective axes substantially parallel to each other along a lateral direction; one or more die cutting members disposed on a major surface of the first roller; one or more fiducial-making members disposed on the major surface of the first roller, laterally adjacent to the die cutting members; and a web conveyed between the first roller and the second roller such that the die cutting members and the fiducial-making members respectively cut a first pattern and a fiducial mark on the same side of the web. The fiducial mark includes one or more fiducial features that only partially penetrate into the web. In some embodiments, the fiducial features include one or more optical fiducial features.

In another aspect, the present disclosure describes a method including providing a first roller and a second roller, each rotatably mounted adjacent to each other with the respective axes substantially parallel to each other along a lateral direction; providing one or more die cutting members disposed on a major surface of the first roller; providing one or more fiducial-making members disposed on the major surface of the first roller, laterally adjacent to die cutting members; and conveying the web between the first and second rollers such that the die cutting members and the fiducial-making members respectively cut a first pattern and a fiducial mark on the same side of the web. The fiducial mark includes one or more fiducial features that only partially penetrate into the web. In some embodiments, the fiducial features can be detected via a photosensor.

Various unexpected results and advantages are obtained in exemplary embodiments of the disclosure. One such advantage of exemplary embodiments of the present disclosure is that a first pattern and an adjacent fiducial mark can be produced in the same die cutting process, and the fiducial mark can be used to register any downstream processes to the first pattern.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a side perspective view of an apparatus, according to one embodiment of the present disclosure.

FIG. 1B is a schematic diagram of a roller having a removable die-cutting member and a removable fiducial-making member, according to one embodiment.

FIG. 1C is a schematic diagram of a roller having a fixed die-cutting member and a removable fiducial-making member, according to another embodiment.

FIG. 1D is a schematic diagram of a roller having a removable die-cutting member and a fixed fiducial-making member, according to another embodiment.

FIG. 1E is a schematic diagram of a roller having a fixed die-cutting member and a fixed fiducial-making member, according to another embodiment.

FIG. 1F is a schematic diagram of a roller having a primary roller with a die-cutting member and a secondary roller with the fiducial-making member, according to another embodiment.

FIG. 1G is an enlarged portion view of an apparatus including a bearer bar.

FIG. 2 is a cross-sectional view of a simplified kiss-cutting member on a cutting die, according to one embodiment of the present disclosure.

FIG. 3A is a plane view of an exemplary cutting die having one pattern of kiss-cutting members, according to one embodiment of the present disclosure.

FIG. 3B is a partial cross-sectional view of the cutting die of FIG. 3A.

FIG. 3C is a perspective view of one kiss-cutting member of FIG. 3A.

FIG. 4 is a top view of a marking die having fiducial-making members, according to one embodiment of the present disclosure.

FIG. 5A is an SEM image of fiducial-making members on a marking die.

FIG. 5B is an SEM image of kiss-cut fiducials on a web made by the fiducial-making members of FIG. 5A.

FIG. 5C is a 3D rendering of the fiducial-making members of FIG. 5A.

FIG. 6A is a block diagram of a downstream station having a registration mechanism, according to one embodiment of the present disclosure.

FIG. 6B is a block diagram of a downstream station having a registration mechanism, according to another embodiment of the present disclosure.

FIGS. 7A-D illustrate a process of downstream registration and printing, according to one embodiment of the present disclosure.

FIG. 8 is a schematic top view of a portion of the web of FIGS. 7B and 7C.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “cutting die” refers to a die plate or rotary tool having a pattern machined into its face as a cutting feature. The pattern may represent the desired artwork to be formed on a substrate when the cutting feature engage with the substrate surface.

The term “marking die” refers to a strip or piece of micro-machinable material with a micro-machined cutting feature formed thereon.

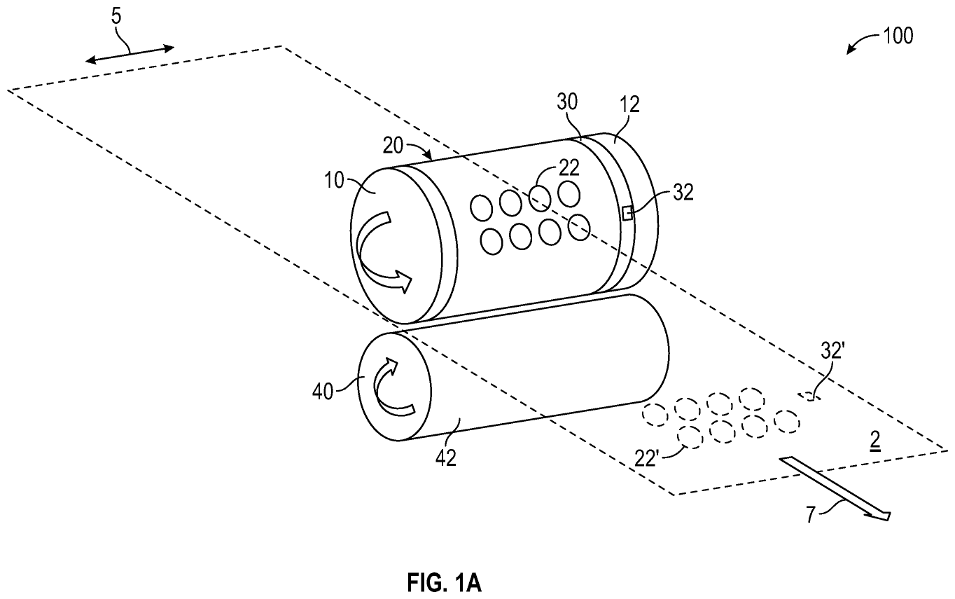

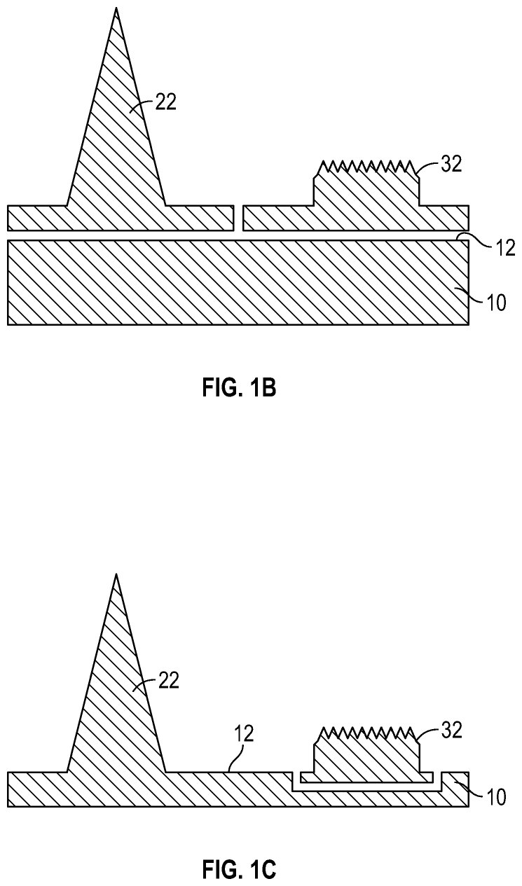

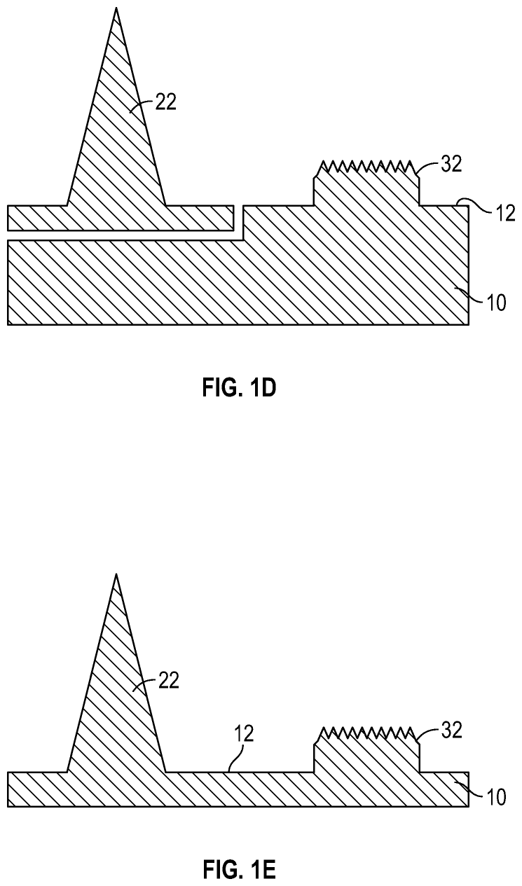

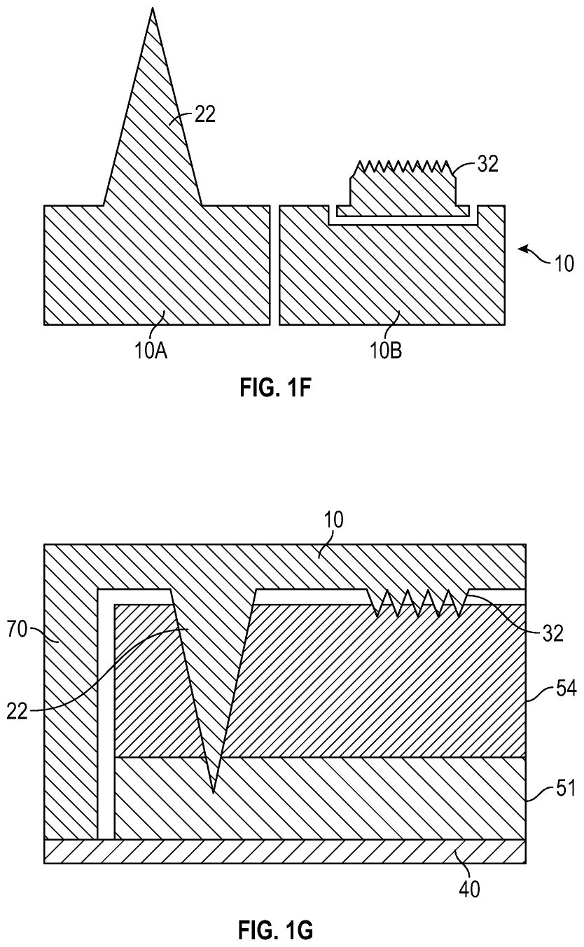

The term “cut” or “cutting” as used in this specification includes, for example, cut through, perforated, score or kiss cut and controlled depth cut segments of a web that is typically a part of or used to make an article. Cut through means that all the layer(s) of a web or an article have been cut. In some cases, a web or article can be cut through so that a segment of the web that has been cut through may be separated from a main segment of the web. Perforated means that a segment of the layers of a web or article has been cut through but sufficient portions of the web/article adjacent or near the cut through segments have been left intact so that the cut segment may not be separate from a main segment(s) of the web without first pulling about or breaking the intact segment(s) of the web. Score or kiss cut means that the cut extends to a specific layer or depth of a web or article without completely penetrating every layer. The use of bearer bars can assist in setting the depth of the kiss cut (see, e.g., FIG. 1G). Typically, this would entail cutting through a coated layer to a liner, but may also include cutting the coated layer to a specific predetermined depth.

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

The terms “about” or “approximately” with reference to a numerical value or a shape means +/− five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

FIG. 1A is a side perspective view of an apparatus 100, according to one embodiment of the present disclosure. The apparatus 100 includes a first roller 10 having a mounting surface 12. A cutting die 20 is attached to the mounting surface 12 of the first roller 10. The cutting dies 20 includes one or more die-cutting members 22 disposed thereon. A marking die 30 is attached to the mounting surface 12, laterally adjacent to the cutting die 20. The marking die 30 includes one or more fiducial-making member 32 disposed thereon. A second roller 40 having a contact surface 42 engages the mounting surface 12 of the first roller 10. The first and second rollers 10 and 40 each are rotatably mounted adjacent to each other with the respective axes parallel to each other along a cross-web or lateral direction 5 to form a web path to covey a web 2.

The web 2 is conveyed along its longitudinal direction 7 (i.e., a machine direction, or a down-web direction). When the web 2 is disposed between the mounting surface 12 of the first roller 10 and the contact surface 42 of the second roller 40, the die-cutting members 22 of the cutting die 20 and the fiducial-making member 32 of the marking die 30 respectively cut a first pattern 22′ and a fiducial mark 32′ on the same side of the web 2, for example, by mechanically deforming of materials therefrom. The fiducial mark 32′ may include one or more fiducial features that only partially penetrate into the web 2. In some embodiments, the fiducial features include one or more optical fiducial features that can be detected via a photosensor. In some embodiments, the web 2 may include a flexible, stretchable material, such as a flexible, polymeric web.

In the embodiment depicted in FIG. 1A, the marking die 30 has a strip shape and mounted on the circumference of the first roller 10, laterally adjacent to the cutting die 20. In some embodiments, the cutting die 20 can be much wider than the marking die 30. For example, the marking die 30 may have a width, for example, about 1/100 to about ⅕ of the width of the cutting die 20. The first pattern formed on the web by the cutting die 20 may occupy a major portion of the web along the cross-web direction, while the fiducial mark formed by the marking die 30 may be positioned adjacent to a longitudinal edge of the web.

The marking die 30 can be separated from the cutting die 20. In some embodiments, the cutting die 20 can be a flexible die and removably attached to the circumference of the first roller 10, while the marking die 30 can be fixed to the circumference of the first roller 10. The cutting die 20 can be replaced with a second cutting die having different cutting patterns thereon, without affecting the marking die 30. In some embodiments, at least one of the cutting die 20 and the marking die 30 can be a flexible die and removably attached to the circumference of the first roller 10, or at least one of cutting die 20 and the marking die 30 can be fixed to the circumference of the first roller 10. The cutting die 20 and/or the marking die 30 can be replaced with a second cutting/marking die having different patterns thereon. It is to be understood that two or more cutting dies can be mounted on the first roller 10; and two or more marking dies can be mounted on the first roller 10.

The die-cutting members 22 of the cutting die 20 are capable of cutting the web surface to form a pattern on the web 2 (e.g., the first pattern 22′). In some embodiments, the cutting die 20 can be a kiss-cutting die having kiss-cutting members to kiss-cut the first pattern on the web surface by selectively deforming materials thereon. The die-cutting members 22 of FIG. 1A include an array of circles. It is to be understood that the die-cutting members 22 can form any desired patterns such as, for example, various shapes with varying diameters and/or pitches.

In some embodiments, the die-cutting members 22 can be solid and mechanically attached to the first roller 10. In some embodiments, the die-cutting members 22 can be formed onto a cutting die that is mechanically attached to the first roller 10. In some embodiments, the die-cutting members 22 can be directly formed onto the major surface 12 of the first roller 10.

In some embodiments, the fiducial-making members 32 can be solid and mechanically attached to the first roller 10. In some embodiments, the fiducial-making members 32 can be formed onto a marking die that is mechanically attached to the first roller 10. In some embodiments, the fiducial-making members 32 can be directly formed onto the major surface 12 of the first roller 10.

In some embodiments, at least one of the die-cutting members 22 and the fiducial-making members 32 can be flexibly and removably attached to the first roller 10. In some embodiments, the die-cutting members 22 can be formed on a flexible cutting die which is removably attached to the first roller 10, and the fiducial-making members 32 can be solid and mechanically attached to the first roller 10. In some embodiments, the die-cutting members 22 can be solid and mechanically attached to the first roller 10, and the fiducial-making members 32 can be formed on a flexible marking die which is removably attached to the first roller 10.

In some embodiments, the first roller 10 may be formed by two or more rollers (e.g., a primary roller, and a secondary roller) that are coaxially arranged side by side. The die-cutting members 22 can be provided on one of the rollers (e.g., the primary roller), and the fiducial-making members 32 can be provided on another roller (e.g., the secondary roller).

FIG. 1B illustrates the first roller 10 where the die-cutting member 22 and the fiducial-making member 32 each are removably mounted on the major surface 12 of the roller 10. FIG. 1C illustrates the first roller 10 where the die-cutting member 22 is fixed (e.g., directly formed or mechanically mounted) on the major surface 12 of the roller 10, and the fiducial-making member 32 is removably mounted. FIG. 1D illustrates the first roller 10 having the removable die-cutting member 22 and the fixed fiducial-making member 32. FIG. 1E illustrates the first roller 10 having the die-cutting member 22 and the fixed fiducial-making member 32 each are fixed on the major surface 12. In FIG. 1F, the roller 10 includes a primary roller 10a with the die-cutting member 22, and a secondary roller 10b with the fiducial-making member 32. The primary and secondary rollers can be coaxially arranged side by side. It will be appreciated that the fiducial-making member and die-cutting member may be exaggerated to provide visual clarity.

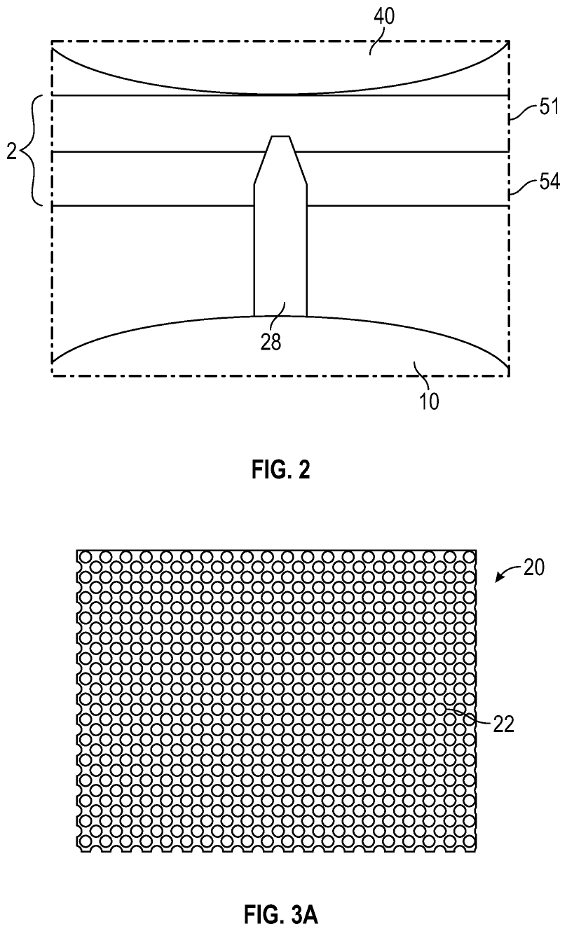

FIG. 2 is a cross-sectional view of a simplified cutting member attached to the first roller 10, according to one embodiment of the present disclosure. The cutting member includes a kiss-cutting member 28 that is a die blade. The first and second rollers 10 and 40 are positioned such that the die blade 28 rotates into cutting engagement with a laminated web 2. The die blade 28 is shown cutting entirely through a first layer 54 of the web 2 but penetrating into only a portion of the second layer 51 of the web 2.

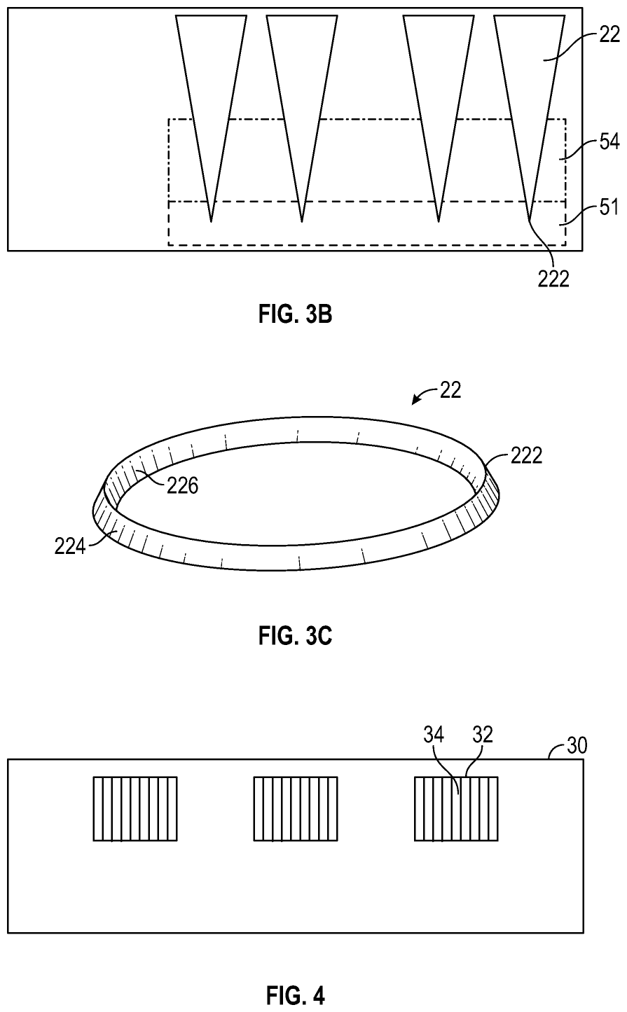

FIG. 3A is a plane view of the exemplary cutting die 20 having a pattern of kiss-cutting members 22 disposed thereon, according to another embodiment of the present disclosure. FIG. 3B is a partial cross-sectional view of the cutting die of FIG. 3A. FIG. 3C is a perspective view of one kiss-cutting member 22. The kiss-cutting members 22 include a cutting blade edge (e.g., the edge 222 in a circle-shape where sloped surfaces 224 and 226 meet) that can cut entirely through the first layer 54 of the web 2 and penetrate into only a portion of the second layer 51 of the web 2.

In some embodiments, the mounting surface 12 of the first roller 10 can be a magnetic mounting surface, and the flexible cutting die 20 can be magnetically attached on the magnetic mounting surface 12. Magnetic bars (not shown) can be attached onto the mounting surface 12 of the first roller 10 to provide sufficient attracting for mounting the cutting die 20. The cutting die 20 can be made of a metal plate where the die-cutting members can be mechanically machined thereon by, e.g., micro-milling. It is to be understood that the cutting die 20 can be made of any suitable materials with cutting members thereon capable of cutting a web surface to form patterns thereon. It is also to be understood that the cutting die can be mounted onto the first roller 20 by any suitable mechanisms.

Referring again to FIG. 1A, the fiducial-making members 32 of the marking die 30 are capable of selectively cutting the surface of the web 2 to form one or more fiducial marks (e.g., the fiducial mark 32′) on the web 2. FIG. 4 is a top view of the marking die 30 having multiple fiducial-making members 32, according to one embodiment of the present disclosure. The multiple fiducial-making members 32 can be arranged along a longitudinal direction of the marking die 30.

At least some of the fiducial-making members 32 include micro-fabricated features 34. The micro-fabricated features may include any suitable micro-machined patterns such as, for example, lines, curves, etc. The micro-fabricated features can be mechanically machined on a fiducial marking die or directly onto a roller surface by, e.g., micro-milling. The micro-milling can be done to metals (e.g., stainless steel, aluminum, steel, copper, etc.), ceramics, various polymers/plastics, etc. It is to be understood that the micro-fabricated features can be made by other suitable methods such as, for example, laser ablation, etching, plating, etc.

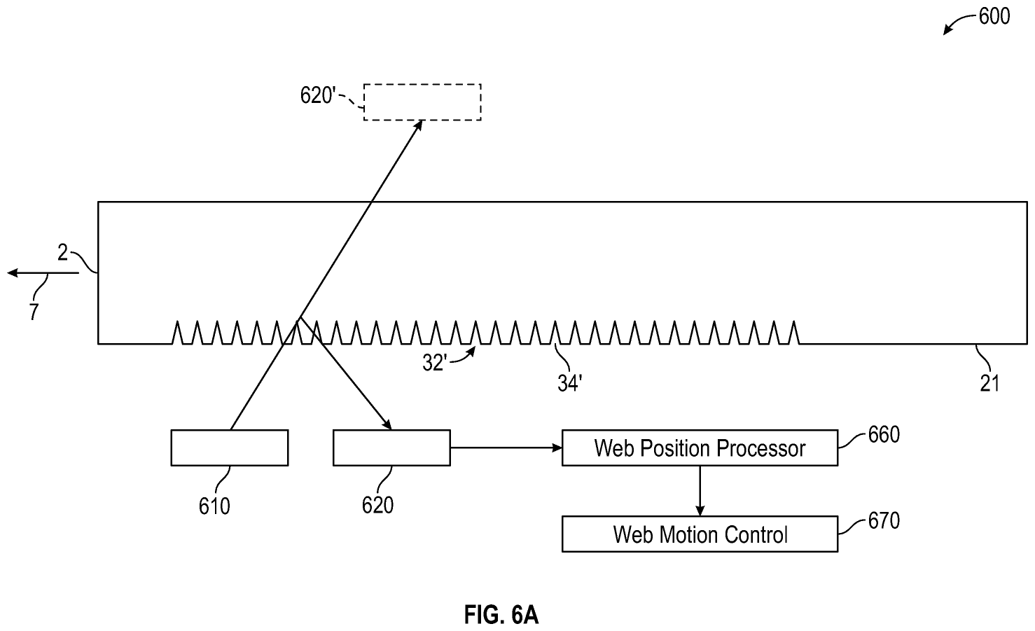

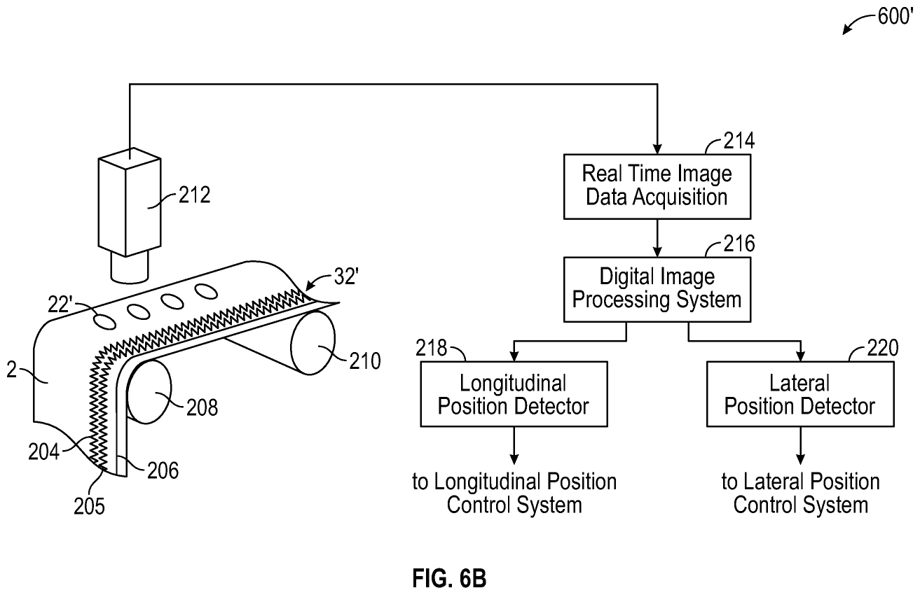

In the embodiment depicted in FIG. 4, the micro-fabricated features 34 include an array of line-shaped blades each extending along the lateral direction (e.g., substantially parallel to the roller axis) when provided on the first roller 10. In some embodiments, the micro-fabricated features 34 can kiss-cut the web surface to form kiss-cut fiducials thereon (see, e.g., kerfs 34′ in FIG. 6A) by deforming materials on the surface of the web 2. The kiss-cut fiducials can form fiducial features that only partially penetrate into the web. That is, the fiducial features may not include any through-holes. In some embodiments, the fiducial features include one or more optical fiducial features that can be detected by a photosensor.

The micro-fabricated features 34 may have a pitch (e.g., a distance between adjacent blades) in a range, for example, from about 10 micrometers to about 1 mm, from about 20 micrometers to about 1 mm, or from about 20 to about 500 micrometers. In some embodiments, the micro-fabricated features 34 of the fiducial-making members 32 may have a characteristic dimension (e.g., a pitch, a depth, etc.) smaller (e.g., at least 2 times, 5 times, or 10 times smaller) than that of the die-cutting members 22.

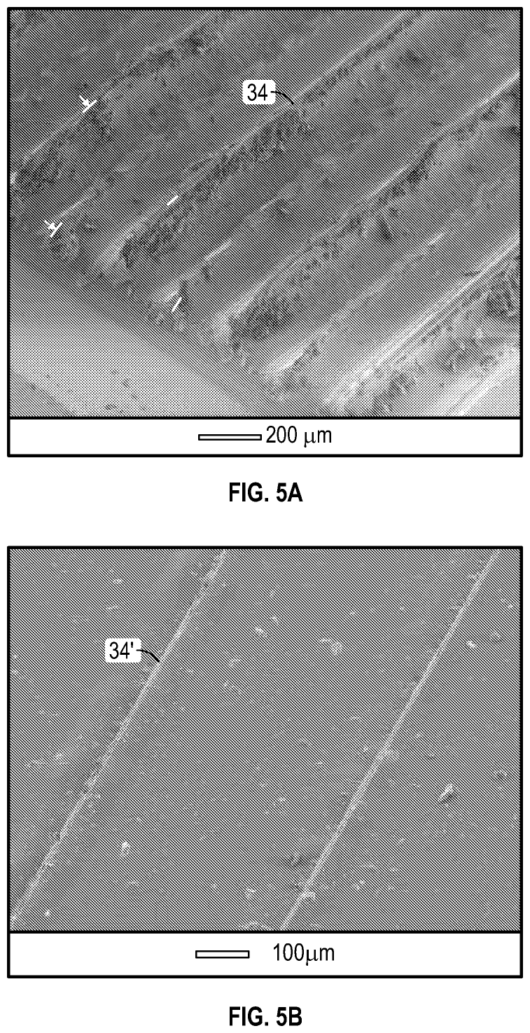

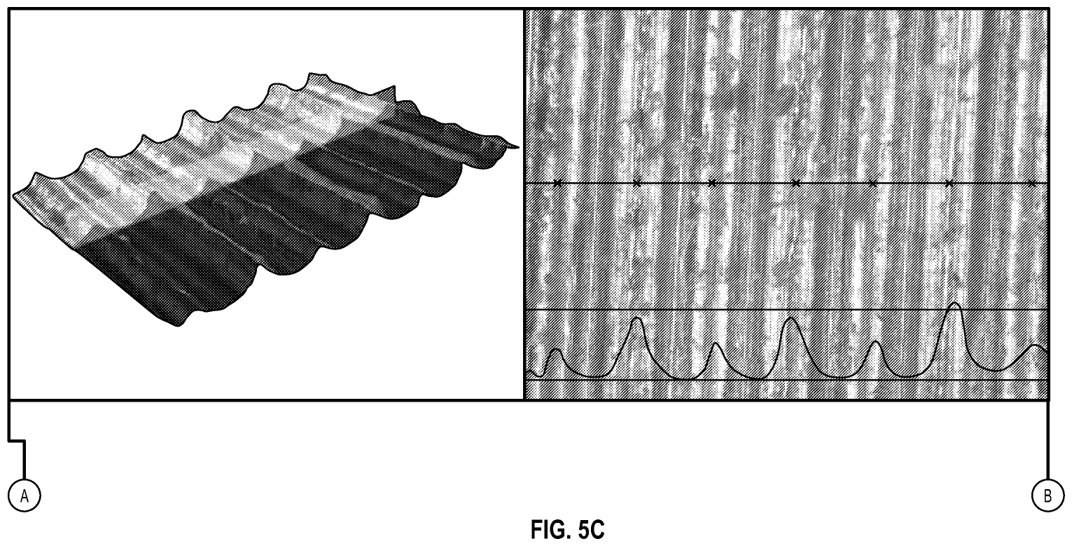

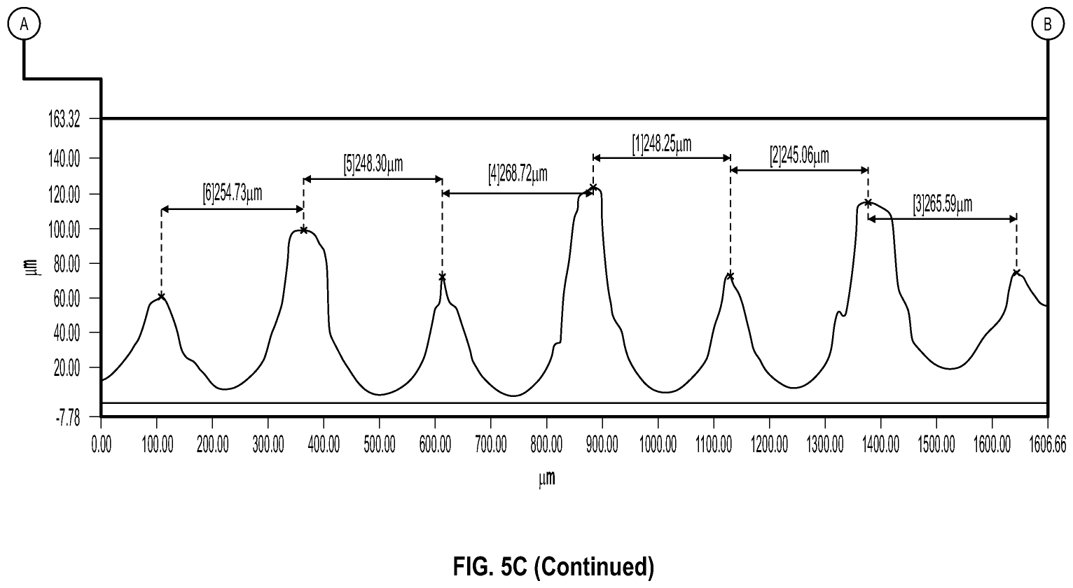

FIG. 5A is an SEM image of exemplary fiducial-making members on a marking die sample. FIG. 5B is an SEM image of kiss-cut fiducials on a PET substrate made by the fiducial-making members of FIG. 5A. FIG. 5C is a 3D rendering of the fiducial-making members of FIG. 5A. In the illustrated sample, the marking die was mechanically machined to make the fiducial-making features 34 on the surface thereof. A Microlution 363-S Micro-milling machine with a 200 um diameter milling bit (commercially available from Microlution, Inc., Chicago, Ill.) was used. The material used for the fiducial marking die was stainless steel. The fiducial-making members include parallel line-shaped blades having a height about 100 micrometers and a pitch about 250 micrometers. The fiducial-making features can kiss-cut the web surface to create fiducial features thereon (e.g., kerfs 34′ as shown in FIG. 5B). In another marking die sample (not shown here), the fiducial-making members include pyramid-shaped blades (having a height about 100 micrometers and a pitch about 200 to 250 micrometers).

In some embodiments, the cutting members 22 of the cutting die 20 and the fiducial-making members 32 of the marking die 30 can rotary-cut the web surface to form the first pattern 22′ and the fiducial mark 32′ on the web 2 at the same time. The respective cutting depths can be predetermined by using suitable cutting members and fiducial-making members. It is to be understood that the cutting members 22 of the cutting die 20 and the fiducial-making members 32 of the marking die 30 may have different cutting depths, which can be independently determined. In some embodiments, the cutting depth of the cutting member of cutting die may be at least 2 times, 5 times, or 10 times greater than that of the fiducial-making member of the marking die. In some embodiments, the cutting depth of the cutting member of cutting die may be in the range of, for example, from 10 micrometers to 1 mm. In some embodiments, the cutting depth of the fiducial-making member of the marking die may be in the range of, for example, from 10 micrometers to 500 micrometers, or from 20 micrometers to 200 micrometers.

In some embodiments, the first roller 10 and/or the second roller 40 can include bearing surfaces, or bearer bars, at or near the extremities of their cylindrical bodies. Exemplary bearers are described in U.S. Pat. No. 5,388,490, which is incorporated by reference herein. As shown in FIG. 1G of the present disclosure, bearer bars 70 on the first roller 10 are in contact with the second roller 40. The dimensions of the bearer bars are predetermined to obtained desired cutting depths for the cutting member 22 and the fiducial-making member 32. In the depicted embodiment of FIG. IF, the cutting member 22 cuts entirely through a first layer 54 of a web, but penetrating into only a portion of the second layer 51 of the web; and the fiducial-making member 32 kiss-cuts the surface of the first layer 54. It will be appreciated that only a portion of the bearer bars 70 and the rollers are shown in the enlarged portion view of FIG. 1G.

After the formation of the first pattern 22′ and the fiducial mark 32′ on the web 2, the web 2 can be conveyed to a downstream station configured to form a second pattern on the web. In some embodiments, the downstream station can include a printing apparatus to print the second pattern on the web. The second pattern may be provided by any suitable processes such as, for example, flexographic printing, gravure printing, screen printing, ink jet printing, dispensing such as piezo dispensing, needle dispensing, etc. To register the second pattern to the fiducial mark and the first pattern, the downstream station can include a registration mechanism to detect the fiducial mark so as to control one or both of the cross web and down web directions within the downstream station.

FIG. 6A is a block diagram of a registration mechanism 600 of a downstream station, according to one embodiment of the present disclosure. The fiducial features 34′ of the fiducial mark 32′ can be made on the web 2 by kiss-cutting the web surface 21 via a marking die including fiducial-making members (e.g., the fiducial-making members 34 of FIG. 5A). The kerfs 34′ of FIG. 6A are the fiducial-making members 34 of FIG. 5A in negative relief The kerfs 34′ only partially penetrate into the web 2 and extend along the cross-web direction (e.g., substantially perpendicular to the web edge).

The registration mechanism 600 of FIG. 6A includes a light source 610, which may be a multi-source array, and one or more photosensors 620 or 620′. The light source 610 directs light toward the web surface having the fiducial features 34′. When the web 2 moves in relation to the light source 610 and the photosensors 620 or 620′ in the machine direction 7, the directed light can be modulated by the fiducial features 34′. In some embodiments, the modulated light may form a high contrast pattern that can be conveniently detected by a sensor such as, for example, a photosensor, a UV fluorescent sensor, etc. The modulated light can be received by the photosensors 620 or 620′ to generate output signals. In some embodiments, the relative motion of the web 2 can cause the light to be modulated sinusoidally. The photosensor 620 can receive light reflected from the web 2; the photosensor 620′ can receive light transmitted through the web 2. The web 2 can be a substantially transparent substrate, or a non-transparent substrate. In some embodiments, when the web 2 is not transparent, and reflects a certain wavelength of light, a difference of reflected light can be detected with and without the fiducial mark. The output signal from the photosensors can be analyzed by a web position processor 660 to determine the position of the web 2. It is to be understood that the light source, the photosensors, and/or the web position processor can be integrated into one device.

With appropriately placed fiducial features 34′, the web position in one or both of the cross web and down web directions can be determined. This information can be used by a web motion or position controller 670 to control a web transport system that moves the web within the downstream position such that the second pattern provided thereon (not shown) can be registered with the fiducial mark 32′. Exemplary position sensor systems are described in U.S. Pat. No. 9,513,412 (Carlson et al.), which is incorporated herein by reference.

FIG. 6B is a block diagram of a registration mechanism 600′ of a downstream station, according to another embodiment of the present disclosure. The web 2 includes the first pattern 22′ and the fiducial mark 32′. In the depicted embodiment of FIG. 6B, the fiducial mark 32′ includes longitudinal fiducial marks including sine and cosine marks 204, 205. The fiducial mark 32′ also includes a horizontal or lateral mark 206. As the web passes between rollers 208, 210, a sensor 212 can sense both the longitudinal fiducial marks 204, 205 and the lateral fiducial mark 206. The sensor 212 may be camera or other type of optical sensor, an electromagnetic sensor, a density sensor, a contact sensor, or any other type of sensor capable of sensing a fiducial mark. In the embodiment illustrated in FIG. 2A, the sensor includes a CCD or CMOS camera.

The output of the camera 212 is directed to image data acquisition circuitry 214 that acquires and digitizes the image of the fiducial marks 204-206 from the camera 212. The digital image of the fiducial marks from the image data acquisition circuitry 214 is directed to a digital image processing system 216. The digital image processing system 216 analyzes the image to generate signals corresponding to the sensed fiducial marks. The signals generated by the digital image processing system 216 may be output to a longitudinal position detector 218 and optionally to a lateral position detector 220. Information from the lateral web position detector 220 may be used by the longitudinal web position detector 218 to enhance interpolation of the longitudinal web position. The longitudinal and lateral position determined by the longitudinal web position detector 218 and the lateral web position detector 220, respectively, may be output to a movement control system configured to control the longitudinal and lateral position of the web. Exemplary position sensor systems are described in U.S. Patent Publication No. 2011/0257779 (Theis et al.), which is incorporated herein by reference.

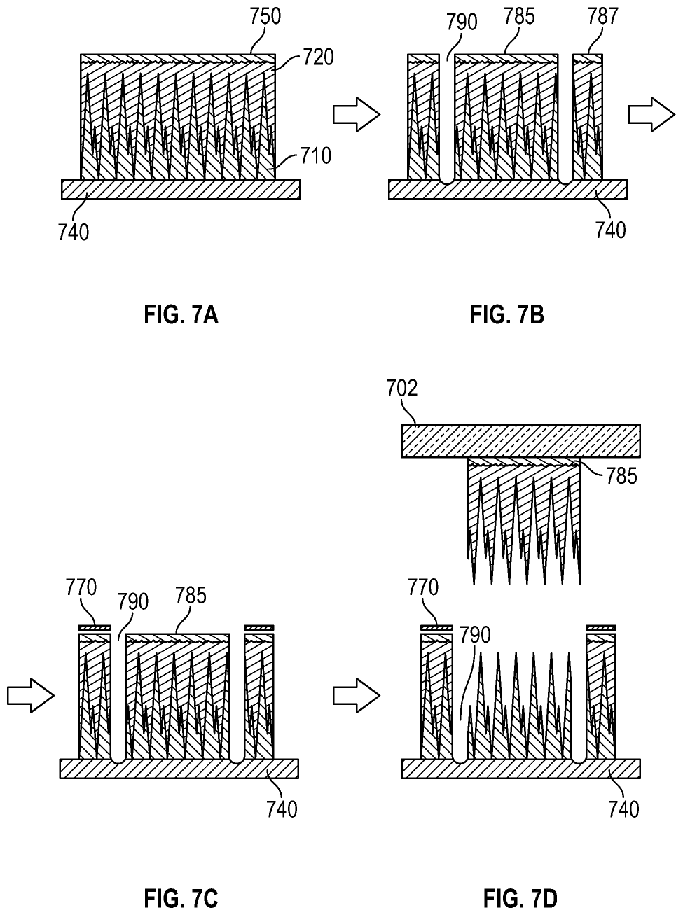

FIG. 7A-D illustrate a process of kiss cutting and downstream registration and printing, according to one embodiment of the present disclosure. As shown in FIG. 7A, a web 2 has laminated layers including a carrier film 740, a template layer 710, a backfill layer 720 and an adhesive layer 750. Exemplary tapes having the structure of web 2 are described in WO 2016/205112 (Wolk et al.), which is incorporated herein by reference. The web 2 is fed to a rotary die cutting apparatus such as the apparatus 100 of FIG. 1A so that the cutting die 20 and the marking die 30 thereof respectively cut a first pattern and a fiducial mark on the same side of the web 2.

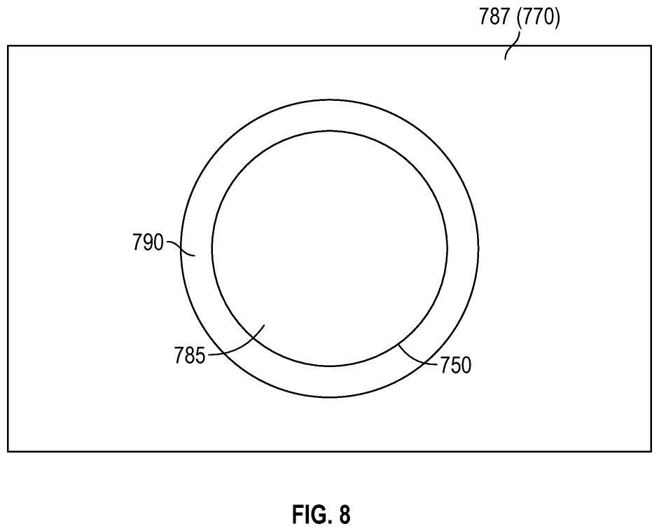

As illustrated in FIG. 7B, the first pattern includes at least one kerf 790 that is formed by a kiss cutting process via cutting members of the cutting die 20 (e.g., the blade 22 of FIG. 3B). The kerf 790 extends through the adhesive layer 750, through the backfill layer 720, and into at least a portion of the carrier film 740. FIG. 8 is a schematic top view of a portion of the web 2 where the first pattern is shown to include the kerf 790 that forms a ring shape. The kerf 790 divided the web surface into a first segment 785 and a second segment 787. The shape of the at least one first segment 785 is defined by the at least one kerf 790.

In the same time, a fiducial mark (e.g., the fiducial mark 32′ of FIG. 1A, not shown in FIGS. 7B-D) is also formed by a kiss cutting process via fiducial-making members of the marking die 30 (e.g., kiss-cutting features in FIGS. 5A-C). The fiducial mark is used to precisely control the cross-web and down-web positions of the web 2 in a downstream station, via a registration mechanism such as described in FIGS. 6A-B.

In the downstream station, a passivating layer 770 is provided onto the second segment 787. The passivating layer 770 can be disposed by, for example, a printing process in the downstream station. The pattern of the passivating layer 770 on the web 2 is registered with respect to the pattern of the kerf 790, which is attributed to the fiducial mark that is used to control the cross-web and down-web positions of the web 2 in the downstream station.

As depicted in FIG. 7D, after the passivating layer 770 is disposed on selected area of the web (e.g., the second segment 787), the adhesive layer 785 is applied to a substrate 702 (e.g., a glass). The portion of backfill layer 720 at the first segment 785 is peeled from the web and disposed on the substrate 702. In some embodiments, the backfill layer 720 can be a light-redirecting material that is deposited on the glass substrate and installed in a window assembly. This enables outside sunlight to be redirected toward the ceiling on the opposite (indoor) side of the window.

The operation of the present disclosure will be further described with regard to the following embodiments. These embodiments are offered to further illustrate the various specific and preferred embodiments and techniques. It should be understood, however, that many variations and modifications may be made while remaining within the scope of the present disclosure.

### Listing of Exemplary Embodiments

It is to be understood that any one of embodiments 1-15 and 16-24 can be combined.
Embodiment 1 is an apparatus comprising:

a first roller and a second roller, each rotatably mounted adjacent to each other with the respective axes substantially parallel to each other along a lateral direction;

one or more die cutting members disposed on a major surface of the first roller;

one or more fiducial-making members disposed on the major surface of the first roller, laterally adjacent to the die cutting members; and

a web conveyed between the first roller and the second roller such that the die cutting members and the fiducial-making members respectively cut a first pattern and a fiducial mark on the same side of the web,

wherein the fiducial mark comprises one or more fiducial features that only partially penetrate into the web.

Embodiment 2 is the apparatus of embodiment 1 further comprising a downstream station configured to provide a second pattern on the web that has the first pattern and the fiducial mark.
Embodiment 3 is the apparatus of embodiment 2, wherein the downstream station further comprises a registration mechanism to detect the fiducial mark and register the second pattern with the fiducial mark.
Embodiment 4 is the apparatus of embodiment 3, wherein the fiducial mark includes one or more optical fiducial features, the registration mechanism comprises a photosensor to detect the optical fiducial features.
Embodiment 5 is the apparatus of embodiment 3 or 4, wherein the registration mechanism comprises a web motion or position controller.
Embodiment 6 is the apparatus of any one of embodiments 2-5, wherein the downstream station further comprises a printing apparatus to print the second pattern on the web.
Embodiment 7 is the apparatus of any one of embodiments 1-6, wherein the die cutting members are disposed on a cutting die that is mounted on the major surface of the first roller.
Embodiment 8 is the apparatus of embodiment 7, wherein the cutting die is a flexible die that is removably attached to the major surface of the first roller.
Embodiment 9 is the apparatus of any one of embodiments 1-8, wherein the fiducial-making members are disposed on a marking die that is mounted on the major surface of the first roller.
Embodiment 10 is the apparatus of embodiment 9, wherein the fiducial-making die is a flexible die that is removably attached to the major surface of the first roller.
Embodiment 11 is the apparatus of any one of embodiments 1-10, wherein the die cutting members include kiss-cutting members to kiss-cut the first pattern on the web.
Embodiment 12 is the apparatus of any one of embodiments 1-11, wherein the fiducial features have a pitch in a range from about 20 micrometers to about 1 mm.
Embodiment 13 is the apparatus of any one of embodiments 1-12, wherein the fiducial features have a depth at least two times smaller than that of the first pattern cut by the die cutting members.
Embodiment 14 is the apparatus of any one of embodiments 1-13, wherein the fiducial features have a depth in a range from about 10 to about 200 micrometers.
Embodiment 15 is the apparatus of any one of embodiments 1-14, wherein the first pattern has a depth in a range from about 10 micrometers to about 1 mm.
Embodiment 16 is a method comprising:

providing a first roller and a second roller, each rotatably mounted adjacent to each other with the respective axes substantially parallel to each other along a lateral direction;

providing one or more die cutting members disposed on a major surface of the first roller;

providing one or more fiducial-making members disposed on the major surface of the first roller, laterally adjacent to die cutting members; and

conveying the web between the first and second rollers such that the die cutting members and the fiducial-making members respectively cut a first pattern and a fiducial mark on the same side of the web,

wherein the fiducial mark comprises one or more fiducial features that only partially penetrate into the web.

Embodiment 17 is the method of embodiment 16 further comprising applying, via a downstream station, a second pattern on the side of the web that has the first pattern and the fiducial mark.
Embodiment 18 is the method of embodiment 17 further comprising registering, via a registration mechanism of the downstream station, the second pattern with the fiducial mark.
Embodiment 19 is the method of embodiment 17 or 18 further comprising detecting, via a photosensor of the downstream station, the fiducial mark that includes one or more optical fiducial features.
Embodiment 20 is the method of any one of embodiments 16-19 further comprising controlling, via a web motion or position controller, to control a web motion or position.
Embodiment 21 is the method of any one of embodiments 17-20, wherein the downstream station further comprises a printing apparatus to print the second pattern on the web.
Embodiment 22 is the method of any one of embodiments 16-21, wherein the die cutting members are disposed on a cutting die that is mounted on the major surface of the first roller.
Embodiment 23 is the method of any one of embodiments 16-22, wherein the fiducial-making members are disposed on a marking die that is mounted on the major surface of the first roller.
Embodiment 24 is the method of any one of embodiments 16-23 further comprising replacing the cutting die with a second cutting die.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. An apparatus comprising:
a first roller and a second roller, each rotatably mounted adjacent to each other with the respective axes substantially parallel to each other along a lateral direction;
one or more die cutting members disposed on a major surface of the first roller;
one or more fiducial-making members disposed on the major surface of the first roller, laterally adjacent to the die cutting members; and
a web conveyed between the first roller and the second roller such that the die cutting members and the fiducial-making members respectively cut a first pattern and a fiducial mark on the same side of the web,
wherein the fiducial mark comprises one or more fiducial features that only partially penetrate into the web.

2. The apparatus of claim 1 further comprising a downstream station configured to provide a second pattern on the web that has the first pattern and the fiducial mark.

3. The apparatus of claim 2, wherein the downstream station further comprises a registration mechanism to detect the fiducial mark and register the second pattern with the fiducial mark.

4. The apparatus of claim 3, wherein the fiducial mark includes one or more optical fiducial features, the registration mechanism comprises a photosensor to detect the optical fiducial features.

5. The apparatus of claim 3, wherein the registration mechanism comprises a web motion or position controller.

6. The apparatus of claim 2, wherein the downstream station further comprises a printing apparatus to print the second pattern on the web.

7. The apparatus of claim 1, wherein the die cutting members are disposed on a cutting die that is mounted on the major surface of the first roller.

8. The apparatus of claim 7, wherein the cutting die is a flexible die that is removably attached to the major surface of the first roller.

9. The apparatus of claim 1, wherein the fiducial-making members are disposed on a marking die that is mounted on the major surface of the first roller.

10. The apparatus of claim 9, wherein the fiducial-making die is a flexible die that is removably attached to the major surface of the first roller.

11. The apparatus of claim 1, wherein the die cutting members include kiss-cutting members to kiss-cut the first pattern on the web.

12. The apparatus of claim 1, wherein the fiducial features have a depth at least two times smaller than that of the first pattern cut by the die cutting members.

13. A method comprising:
providing a first roller and a second roller, each rotatably mounted adjacent to each other with the respective axes substantially parallel to each other along a lateral direction;
providing one or more die cutting members disposed on a major surface of the first roller;
providing one or more fiducial-making members disposed on the major surface of the first roller, laterally adjacent to die cutting members; and
conveying the web between the first and second rollers such that the die cutting members and the fiducial-making members respectively cut a first pattern and a fiducial mark on the same side of the web,
wherein the fiducial mark comprises one or more fiducial features that only partially penetrate into the web.

14. The method of claim 13 further comprising applying, via a downstream station, a second pattern on the side of the web that has the first pattern and the fiducial mark.

15. The method of claim 14 further comprising registering, via a registration mechanism of the downstream station, the second pattern with the fiducial mark.

16. The method of claim 15 further comprising detecting, via a photosensor of the downstream station, the fiducial mark that includes one or more optical fiducial features.

17. The method of claim 15 further comprising controlling, via a web motion or position controller, to control a web motion or position.

18. The method of claim 15, wherein the downstream station further comprises a printing apparatus to print the second pattern on the web.

19. The method of claim 13, wherein the die cutting members are disposed on a cutting die that is mounted on the major surface of the first roller.

20. The method of claim 13, wherein the fiducial-making members are disposed on a marking die that is mounted on the major surface of the first roller.

21. (canceled)
